(19) United States
(12) Patent Application Publication
(10) Pub. No.: US 2022/0156421 A1
(43) Pub. Date: May 19, 2022

(54) FLUID DISTRIBUTION SYSTEM SOLUTION GENERATOR

(71) Applicant: Swagelok Company, Solon, OH (US)

(72) Inventors: Mijo Dejanovic, Windham, OH (US); Kristopher Scott Owens, Brook Park, OH (US); Joseph Rodriguez, Solon, OH (US); Tony Yagiela, Sagamore Hills, OH (US); John Mark Buber, Chesterland, OH (US); Matt Dixon, Parma, OH (US)

(21) Appl. No.: 17/528,291

(22) Filed: Nov. 17, 2021

Related U.S. Application Data
(60) Provisional application No. 63/115,212, filed on Nov. 18, 2020.

(51) Int. Cl. G06F 30/12; G06F 30/18; B29C 64/393; B33Y 80/00; B33Y 50/02; G06Q 10/08

(52) U.S. Cl. CPC G06F 30/12; G06F 30/18; B29C 64/393; G06F 2113/08; B33Y 50/02; G06Q 10/0875; B33Y 80/00

(57) ABSTRACT

Exemplary systems and methods for generating fluid distribution system solutions are provided. A user interface is provided that enables user to make selections relating to components and/or characteristics of a target fluid distribution system. The interface is configured to provide feedback based on user selections and verify that the selections are compatible. Exemplary systems and methods are configured to verify the user input and generate a target fluid distribution system solution based on the input.

### CROSS REFERENCE TO RELATED APPLICATION

The present application claims priority to and all benefit of U.S. Provisional Patent Application Ser. No. 63/115,212, filed on Nov. 18, 2020, entitled FLUID DISTRIBUTION SYSTEM SOLUTION GENERATOR, the entire disclosure of which is fully incorporated herein by reference.

### TECHNICAL FIELD

The present disclosure generally relates to systems and methods for generating fluid distribution system solutions.

### BACKGROUND

In the field of fluid distribution, the conception, design, and implementation of distribution systems is a burdensome process involving many layers of human involvement in order to deliver fluid distribution solutions to customers. Customers rely on these distribution systems to deliver fluid to lab benches, equipment, or processes. Depending on the application, each system has a number of parameters that require tailored solutions. Typically, a salesperson works with a customer to document what parameters a particular fluid distribution project requires, then a team of engineers must design a system, test and verify compatibility of components, compile parts lists and other documentation, develop a plan for implementation, among other steps, all before the final solution can be delivered to the customer. Furthermore, this process may be duplicated many times over as different customers require similar configurations but are unable to leverage a unified platform for designing and building the distribution systems.

### SUMMARY

In an exemplary embodiment, a system for generating a fluid distribution system solution is provided. The system comprises a user interface module configured to accept at least one user input related to a target fluid distribution system, wherein the target fluid distribution system has a plurality of components; a solution generation module configured to generate the target fluid distribution system based on the at least one user input and at least one input generated by the solution generation module, generate a 3D model representative of the target fluid distribution system, and, display the 3D model at the user interface module; and a network configured to connect the user interface module and the solution generation module.

In another exemplary embodiment, a method for generating a fluid distribution system solution is provided. The method comprises accepting at least one user input related to a target fluid distribution system, wherein the target fluid distribution system has a plurality of components; generating the target fluid distribution system based on the at least one user input and at least one input generated by the solution generation module; generating a 3D model representative of the target fluid distribution system; displaying the 3D model at a user interface; and, storing information related to the generated target fluid distribution system at a storage.

In yet another exemplary embodiment, a method for generating a fluid distribution system solution is provided. The method comprises accepting a plurality of user inputs related to a target fluid distribution system, wherein the target fluid distribution system has a plurality of components; modifying available user input selections based on subsequent inputs of the plurality of user inputs; generating the target fluid distribution system based on the plurality of user inputs; and, storing information related to the generated target fluid distribution system at a storage.

These and other objects, features and advantages of the present disclosure will become apparent from the following detailed description of illustrative embodiments thereof, which is to be read in connection with the accompanying drawings.

### BRIEF DESCRIPTION OF THE DRAWINGS

These and other features of the present disclosure will become better understood with regard to the following description and accompanying drawings in which:

FIG. 1 illustrates and exemplary system for generating a fluid distribution system;

FIG. 2 illustrates and exemplary method for generating a fluid distribution system;

FIG. 3 illustrates an exemplary user interface for generating a fluid distribution system;

FIG. 4 illustrates an exemplary bill of materials generated by a system for generating a fluid distribution system; and,

FIG. 5 illustrates an exemplary 3D model generated by a system for generating a fluid distribution system.

### DETAILED DESCRIPTION

Aspects and implementations of the present disclosure will be understood more fully from the detailed description given below and from the accompanying drawings of the various aspects and implementations of the disclosure. This should not be taken to limit the disclosure to the specific aspects or implementations, but explanation and understanding only. While certain exemplary embodiments are described with reference to fluid distribution systems, it is appreciated that the described embodiments would be readily adaptable for distribution of various fluids (e.g. gases, liquids, and/or plasmas).

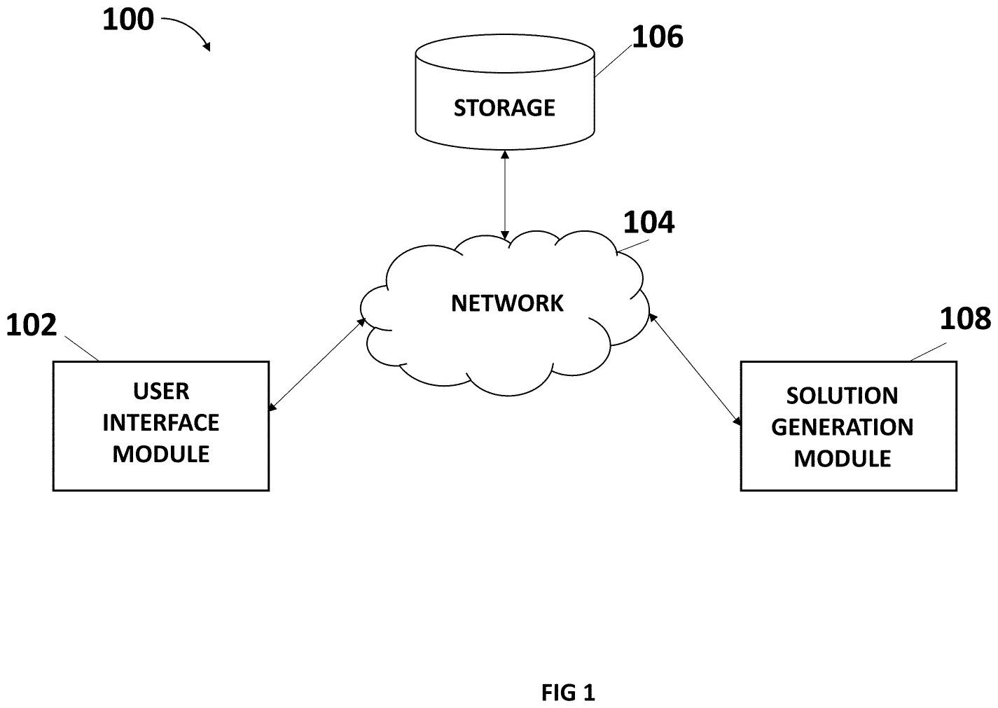

FIG. 1 shows an exemplary system 100 for generating a fluid distribution system solution. The system 100 comprises at least a user interface module 102 and a solution generation module 108 which are in communication via a network 104.

User interface module 102 is configured to accept user inputs related to a target fluid distribution system. It is appreciated a target fluid distribution system is a solution that may be used to assemble a real-life physical fluid distribution system. User interface module 102 may be configured to operate in conjunction with a user device operable to make selections via one or more user input devices. In certain embodiments, user interface module 102 is accessible over a network (e.g. network 104) via a computer, tablet, or the like connected to the Internet, for example, using a web browser. In certain other embodiments, user interface module 102 may be operable without an Internet connection. It is further appreciated that user interface module 102 is operably connected to at least one display. User interface module 102 may present options for user input in the form of parameters related to the target fluid distribution system, components for use in the target fluid distribution system, existing distribution infrastructure parameters, etc. In some embodiments, parameters may be automatically populated based on a selection of system type (e.g. source panel, automatic changeover, point-of-use, multisource, etc.). The available inputs may be updated in real-time or near real-time over network 104 based on component availability, recall information, pricing information, etc. As user interface module 102 accepts user inputs, the user interface module 102 is configured to narrow possible parameter and/or component combinations and reconfigure options available for additional user input. For example, if user input dictates an oxygen-based target fluid distribution system, parameters related to inert fluid distribution systems will be removed. Certain parameters may only be available based on the type of fluid in the target fluid distribution system. In some embodiments, user interface module 102 can be configured in “expert mode” which overrides the removal of options in order for testing of various component configurations. In “expert mode” a user can manually input a part number instead of choosing options from a list. Similarly, in some embodiments, user interface module 102 is configured to make recommendations for subsequent inputs based on customer information associated with the user and/or previously configured fluid distribution systems for the user or other users. In some embodiments a user can search for prior configured systems and/or components. It is appreciated that as more target distribution systems are generated and stored, more accurate recommendations may be made by the user interface module 102. Metrics related to a particular component and/or parameter may also be displayed at user interface module 102 in order to better assist the user in configuring their target distribution system. The metrics may also comprise information related to observed characteristics of those generated distribution systems that are deployed in the field. Such information can be used by user interface module 102 to determine efficiency of certain configurations versus alternative configurations and make appropriate recommendations. In certain embodiments, user interface module 102 may reconfigure available options and/or parameters presented to a user based on one or more design tables.

User interface module 102 is connected to other resources in system 100 via network 104. Network 104 is a communication network such as the Internet, intranet, or the like. It is appreciated that various authentication protocols may be employed to secure access to the resources of system 100 over network 104. In some embodiments, network 104 is in communication with storage 106. Storage 106 may be one or more servers or the like connected to network 104 configured to store information related to system 100, for example, customer information, historical data related to prior configured fluid distribution systems, design tables, error information, health and safety information, regulatory requirements, etc. It is appreciated that user interface module 102 may utilize information stored at storage 106 and/or store new information at storage 106 via network 104.

According to exemplary embodiments, once the user has made a sufficient number of inputs to generate a complete fluid distribution system, the target fluid distribution system can be generated at solution generation module 108. Solution generation module 108 is configured to verify that the selected user inputs are compatible and that the target fluid distribution system is capable of real-life physical configuration and assembly. In some exemplary embodiments, a user will not be shown the option to configure a system until one or more part numbers of selected components are verified. In some embodiments, user interface module 102 may prompt a user when a sufficient number of inputs have been received in order to configure a complete target fluid distribution system. If certain inputs are not compatible, user interface module 102 may generate and display a warning or other error message. In some embodiments, analytical information relating to configuration requests is generated and sent to an engineering team for analysis. In some embodiments, user interface module 102 may generate a notice whenever a novel configuration is entered. If the selected inputs correspond to a previously configured system (e.g. a configuration stored at storage 106) user input module 102 may display a notification that such a system has already been configured. Therefore, the existing problems resulting from duplication of work can be avoided. Solution generation module 108 may rely on design tables or other engineering data in order to generate the target fluid distribution system according to the user inputs as received at user interface module 102.

In some embodiments solution generation module 108 is configured to generate a model representative of the target distribution system. The model may be a 2-Dimensional (2D) or 3-Dimensional (3D) model. The model can be helpful for the user to see the physical organization of components and determine if the generated target system is suitable for their application. The model may also be expandable (e.g. exploded view) such that individual components can be seen. In some embodiments, a 3D model is viewable at user interface 102 without the need for additional specialized software for viewing 3D models. In other embodiments, solution generation module 108 generates a 3D model as a file which can be opened using such specialized software for viewing 3D models. In certain embodiments, the model is built and updated throughout multiple stages of user input. For example, solution generation module 108 may begin generating the model before every user input is completed, saving processing resources. Additionally, if a user makes changes to the inputs and wants to reconfigure the target system, solution generation module 108 may use a prior generated model to start with instead of regenerating an entirely new model, decreasing the time required to generate the updated model. Once the model is generated it may be stored in storage 106. In certain embodiments, user interface 102 may be configured to compare the model of the generated target fluid distribution system with other models of similar systems. It is appreciated that in certain embodiments, system 100 may be configured to initiate printing of a representative 3D model of the target fluid distribution system using one or more 3D printers.

In some embodiments, solution generation module 108 may generate documentation related to the generated target fluid distribution system. For example, solution generation module 108 may generate a bill of materials (BOM) which lists information related to the components used in the generated target fluid distribution system. For each component of the generated system, the BOM may list a part number (which may be utilized in a system identifier), a description of the component, quantity of component required, etc. Solution generation module 108 may generate the BOM in various formats (e.g. spreadsheet, pdf, etc.) in order to robustly document the generated system and its component parts. In certain embodiments, the BOM may be used by the solution generation module 108 to generate real-time or near real-time sales and quote data related to the target fluid distribution system and/or its components.

In some embodiments, as inputs are accepted at user interface module 102, a system identifier is generated which describes the target fluid distribution system. For example, as each parameter/component is selected, an alphanumeric code representing each selection is combined with the other selected parameters/components to create a singular identifier for the target system. Each identifier describes the system and its parameters and/or components. Each identifier could then be used to easily catalogue the specific configuration of the system, for example, at storage 106. An identifier may be unique for every system configured, i.e. may contain time and date information related to when the system was generated, or in the alternative, an identifier may be used for two or more systems with the same parameter/component configuration. In certain embodiments, the system identifier is used to verify the authenticity and/or compatibility of the generated system. In some embodiments, the identifier may be a Part Number (PN).

It is a further aspect of system 100 that once a target fluid distribution system is generated, information related to the component parts of the target system is constantly updated such that if there are errors, product failures, recalls, or the like associated with an individual component and/or similar configurations, system 100 can easily identify which distribution systems were configured and/or physically built/deployed and notify the affected users/customers. In such situations, system 100 may make recommendations on alternative configurations to replace the defective component based at least on prior configured systems (e.g. those stored at storage 106). In some embodiments, system 100 can generate one or more analytical tools describing the generated configurations. For example, such analytical data may comprise how often a given configuration and/or individual components are used in a particular region and/or globally. The analytical data may include, but is not limited to, sales data, quote data, and/or performance data for generated configurations and/or individual components. Another aspect of system 100 is that once a target fluid distribution system is configured, fabrication and supply chain information may be associated with the configuration, including lead times for projected fabrication of the configured system. In certain embodiments, lead times may be updated in real-time or near real-time based on regional, local, and global internal and external supply chains. In such embodiments, system 100 may generate one or more notifications to inform a user of a projected fabrication date, which may then be updated based on analysis of the supply chains involved in the fabrication of the given configuration.

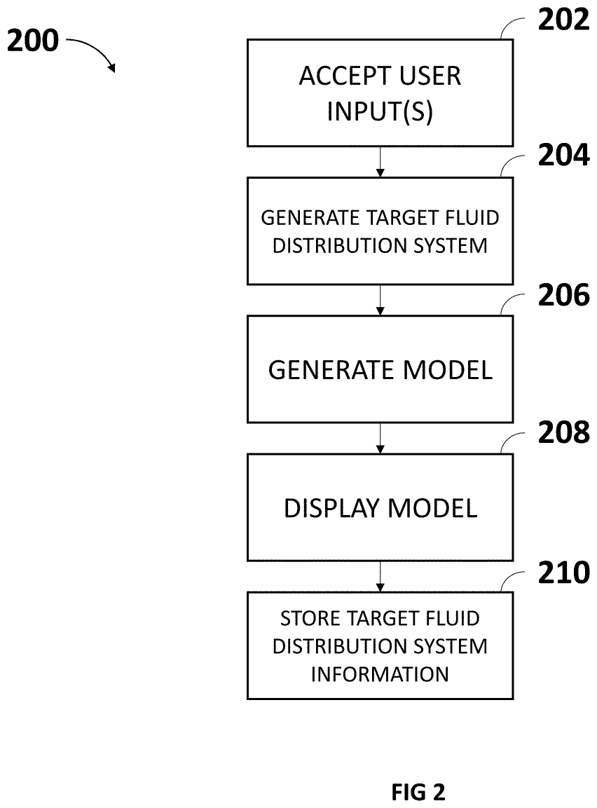

FIG. 2 illustrates a flow chart of an exemplary method 200 for generating a fluid distribution system. It will be appreciated that the illustrated method and associated steps may be performed in a different order, with illustrated steps omitted, with additional steps added, or with a combination of reordered, combined, omitted, or additional steps. Method 200 begins with accepting user input(s) at step 202. User inputs may be accepted/received at a user interface (e.g. user interface module 102). At step 204 a target fluid distribution system is generated (e.g. by solution generation module 108). At step 206 a model representative of the target fluid distribution system is generated. At step 208, the model is displayed, for example, at a display associated with user interface module 102. At step 210, the target fluid distribution system configuration, including but not limited to the representative model and/or associated BOMs is stored, for example, at storage 106.

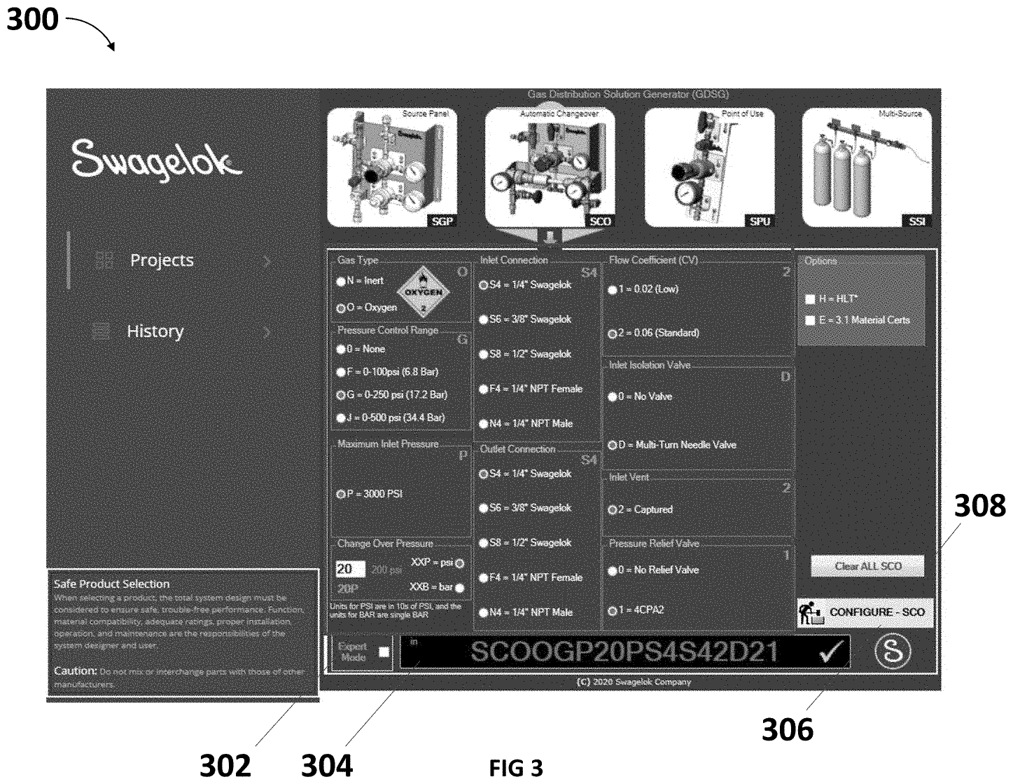

FIG. 3 shows an exemplary user interface 300 for generating a fluid distribution system. User interface 300 comprises at least component/parameter input(s) 302 and system identifier 304. The system identifier 304 may be updated in real-time or near real-time as selections of component/parameter input(s) 302 are made at the user interface 300. The system identifier 304 may comprise an aggregate product number based on the product numbers of the one or more component/parameter input(s) 302. In certain embodiments, a checkmark or similar graphic may appear once a sufficient number of component/parameter input(s) 302 have been made in order to generate a complete target fluid distribution system. If a system identifier 304 is recognized as corresponding to a system that has already been configured, a user may be given the option to review information relating to the previously configured systems, view a 2D or 3D model of the previously configured systems, and/or configure a new system using the selected component/parameter input(s) 302.

In certain embodiments, user interface 300 may define one or more sub-systems of a target fluid distribution system. In such embodiments, a user may be prompted to make component/parameter selections for each subsystem separately. It is appreciated that verification of the component/parameter inputs via system identifier 304 may be done at either the sub-system level or system-wide level. In some embodiments, the system identifier 304 aggregates all component/parameter input(s) 302 (regardless if they are made in connection with different subsystems) into the system identifier 304. In some embodiments, the user interface may generate a separate sub-system system identifier. Once a sufficient number of component/parameter input(s) 304 have been selected the user can configure a target fluid distribution system using configure button 306. It is appreciated that in certain embodiments, the configure button 306 will not appear or will otherwise be unselectable by the user until verification of the component/parameter input(s) 304 is complete. While shown as radial buttons and/or check boxes, it is appreciated that the selection mechanisms of user interface 300 may vary, including but not limited to, drop down boxes or the like. In some embodiments, user interface 300 includes a “clear” button 308 that will clear all selections and allow the user to start over the configuration process. In some embodiments, a user may input a system identifier 304 and selections corresponding to that particular system identifier may be automatically filled in. In some embodiments, training information may be available within user interface 300 that can guide a user to making appropriate selections to build a target fluid distribution system. It is appreciated that in certain embodiments a user may save their progress within user interface 300 so that the configuration process may be picked up at a later time. In some embodiments, user interface 300 may allow a user to download full or partial configurations and any associated data to a local storage.

It is appreciated that for each possible component/parameter input(s) 302, additional textual and/or visual data may be associated with the selection. For example, a particular component may be linked to one or more datasheets or other technical information about the component and/or its use in other configured fluid distribution systems. In some embodiments, visual data associated with component/parameter input(s) 302 may comprise a 2D or 3D model of the component, or a photograph of the actual component.

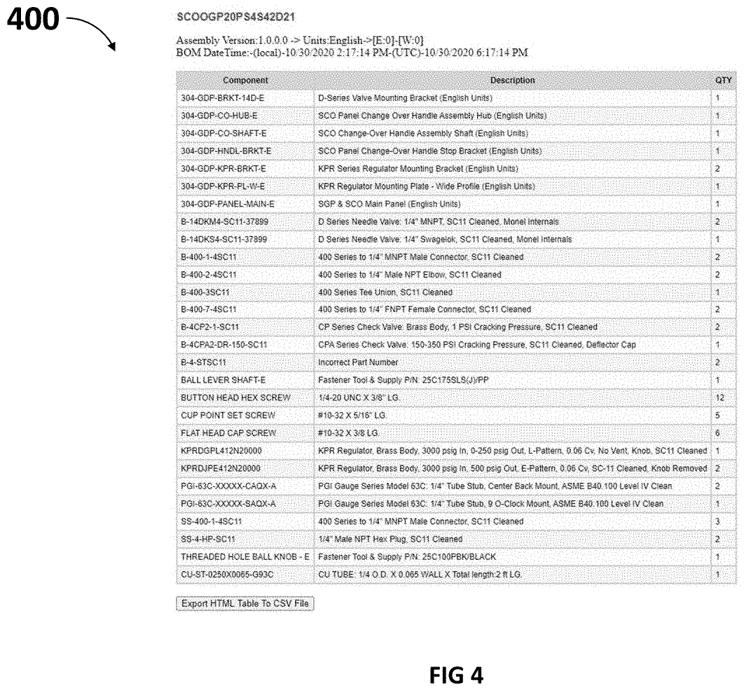

FIG. 4 shows and exemplary bill of materials (BOM) 400 generated in connection with a generated fluid distribution system (e.g. system 100). BOM 400 may include information related to the components of the target fluid distribution system such as, for example, part number, component description, quantity needed, etc. In certain embodiments, pricing information is generated along with the BOM 400. In some embodiments, BOM 400 may be customized by region, language, customer requirements/requests, measurement units, etc.

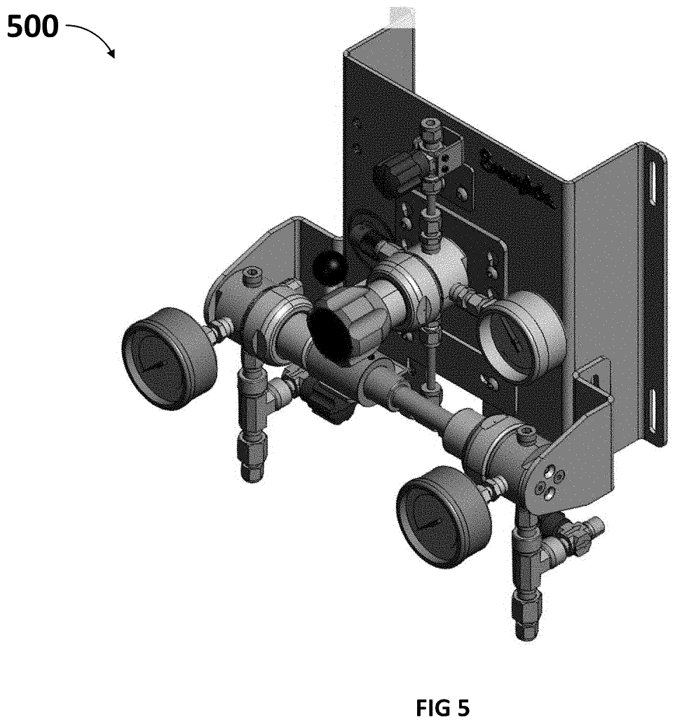

FIG. 5 shows an exemplary 3D model 500 generated in connection with a generated fluid distribution system solution (e.g. system 100). It is appreciated that 3D model 500 is only one exemplary view of the generated 3D model 500 and that in exemplary embodiments, 3D model 500 can be manipulated by a user, such as, for example, rotated, expanded, exploded, etc. In some embodiments, a user interface (e.g. user interface module 102) can display multiple 3D models at once and/or multiple views of the same model. 3D model 500 may identify critical and/or dangerous connection points on the model, for example, by highlighting the connection point using a different color and/or generating text notifications identifying the connection point at issue. It is appreciated that in some embodiments system 100 (e.g., via user interface 300) may generate a 2D model of a fluid distribution system. In certain embodiments, 2D or 3D models may be generated and viewed within user interface 300, for example, in a web browser, without the need for any specialized 3D model viewing software. In certain embodiments the generated 2D or 3D model is automatically updated based on changes to one or more input parameters. In some embodiments, 3D model 500 may be used to animate a fluid flow simulation for a configured target fluid distribution system.

The term “module” or “engine” used herein will be appreciated as comprising various configurations of computer hardware and/or software implemented to perform operations. In some embodiments, modules or engines as described may be represented as instructions operable to be executed by a processor and a memory. In other embodiments, modules or engines as described may be represented as instructions read or executed from a computer readable media. A module or engine may be generated according to application specific parameters or user settings. It will be appreciated by those of skill in the art that such configurations of hardware and software may vary, but remain operable in substantially similar ways.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include the specified value, values within 5% of the specified value, and values within 10% of the specified value, unless expressly stated otherwise. Further, it is to be understood that the drawings accompanying the present disclosure may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

1. A system for generating a fluid distribution system solution, the system comprising:
a user interface module configured to accept at least one user input related to a target fluid distribution system, wherein the target fluid distribution system has a plurality of components;
a solution generation module configured to
generate the target fluid distribution system based on the at least one user input,
generate a model representative of the target fluid distribution system, and,
display the model at the user interface module; and
a network configured to connect the user interface module and the solution generation module.

2. The system of claim 1, wherein the solution generation module is further configured to verify the at least one user input before generating the target fluid distribution system.

3. The system of claim 1, wherein the solution generation module is further configured to verify that the at least one user input comprises confirming that the at least one user input will result in a possible real-life physical configuration of the target fluid distribution system.

4. The system of claim 3, wherein the user interface module is configured to permit a user to override the verification performed by the solution generation module if the user is in expert mode.

5. The system of claim 1, wherein the solution generation module is configured to generate a warning notification if verification of the at least one user input fails.

6. The system of claim 1, wherein the solution generation module is further configured to receive a second user input related to the target fluid distribution system; and reconfigure the generated target fluid distribution system based on at least the second user input.

7. The system of claim 1, wherein the user interface module is configured to modify possible input options based on the at least one user input.

8. The system of claim 1, wherein the solution generation module is further configured to generate a Bill of Materials (BOM) based on the target fluid distribution system.

9. The system of claim 8, wherein the BOM comprises real-time pricing information related to at least one component of the target fluid distribution system.

10. The system of claim 1, wherein the solution generation module is further configured to initiate printing of a 3D model representative of the target fluid distribution system using one or more 3D printers.

11. (canceled)

12. (canceled)

13. A method for generating a fluid distribution system solution, the method comprising:
accepting at least one user input related to a target fluid distribution system, wherein the target fluid distribution system has a plurality of components;
generating the target fluid distribution system based on the at least one user input and at least one input generated by a solution generation module;
generating a model representative of the target fluid distribution system;
displaying the model at a user interface; and,
storing information related to the generated target fluid distribution system at a storage.

14. The method of claim 13, wherein the at least one input generated by the solution generation module is based on the at least one user input.

15. The method of claim 13, further comprising generating a plurality of inputs at the solution generation module based on the at least one user input.

16. The method of claim 15, wherein the plurality of inputs are verified before generating the target fluid distribution system.

17. The method of claim 16, wherein verification comprises confirming that the inputs will result in a possible real-life physical configuration of the target fluid distribution system.

18. The method of claim 17, further comprising generating a warning notification if the verification fails.

19. The method of claim 13, further comprising generating a Bill of Materials (BOM) based on the target fluid distribution system.

20. The method of claim 19, wherein the BOM comprises real-time pricing information related to at least one component of the target fluid distribution system.

21. The method of claim 13, further comprising printing a 3D model representative of the target fluid distribution system using one or more 3D printers.

22. A method for generating a fluid distribution system solution, the method comprising:
accepting a plurality of user inputs related to a target fluid distribution system, wherein the target fluid distribution system has a plurality of components;
modifying available user input selections based on subsequent inputs of the plurality of user inputs;
generating the target fluid distribution system based on the plurality of user inputs; and,
storing information related to the generated target fluid distribution system at a storage.
